(19) United States
(12) Patent Application Publication
(10) Pub. No.: US 2026/0179586 A1
(43) Pub. Date: Jun. 25, 2026

(54) Fan Blade Percussion Bell Cowbell

(71) Applicant: Jeremy Howard, Portland, OR (US)

(72) Inventor: Jeremy Howard, Portland, OR (US)

(21) Appl. No.: 18/991,422

(22) Filed: Dec. 21, 2024

(51) Int. Cl. G10D 13/06

(52) U.S. Cl. CPC G10D 13/06

(57) ABSTRACT

A bell, often referred to as a cowbell intended to be used as a percussion instrument. This claim is for a new construct feature that improves upon the performance of a percussion bell. The new feature of this percussion bell is the inclusion of lips that extend down bast the body of the bell. The inclusion of these lips improves upon the resonance of the bell when struck.

### DESCRIPTION OF THE NATURE AND INTENDED USE OF THE ARTICLE

A bell, often referred to as a cowbell intended to be used as a percussion instrument.

### RELATED APPLICATIONS

A Design Patent related to this application by the same applicant shall be submitted concurrently.

### DESCRIPTION OF IMAGES

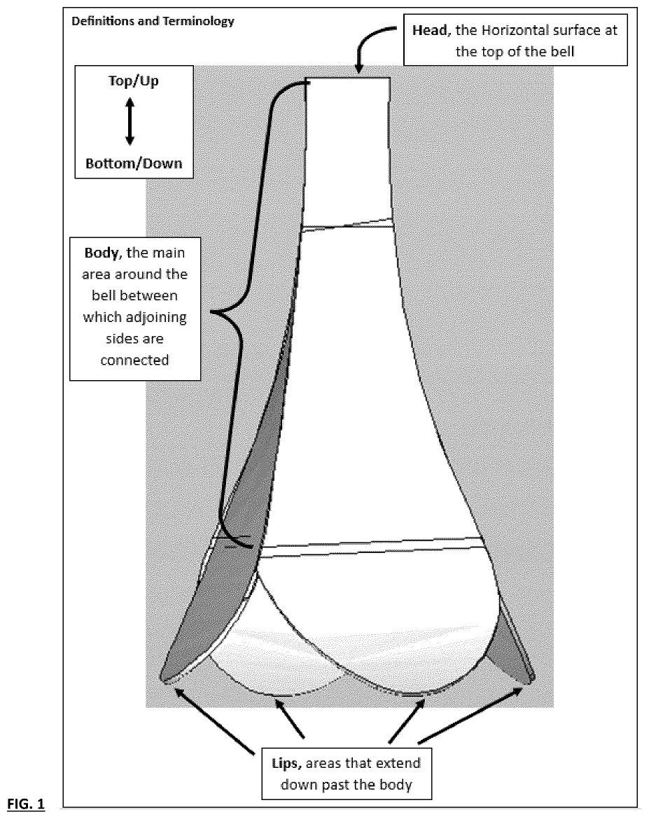

FIG. 1 is an image showing definitions and terminology of my percussion cowbell;

FIG. 2 is a three-quarter upright view computer drawing of a percussion cowbell showing my new design;

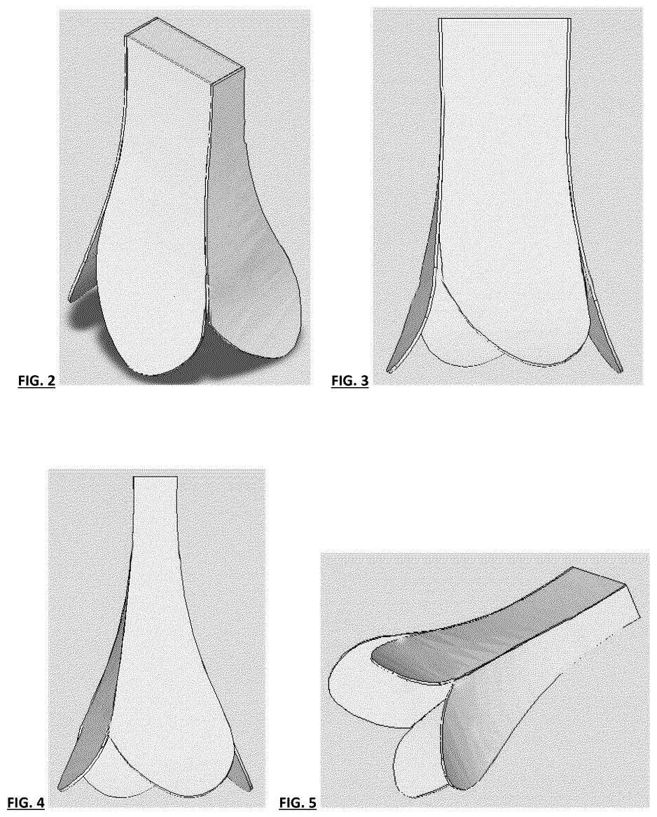

FIG. 3 is a front upright view computer drawing of a percussion cowbell showing my new design;

FIG. 4 is a front side view computer drawing of a percussion cowbell showing my new design;

FIG. 5 is a three-quarter side view computer drawing of a percussion cowbell showing my new design;

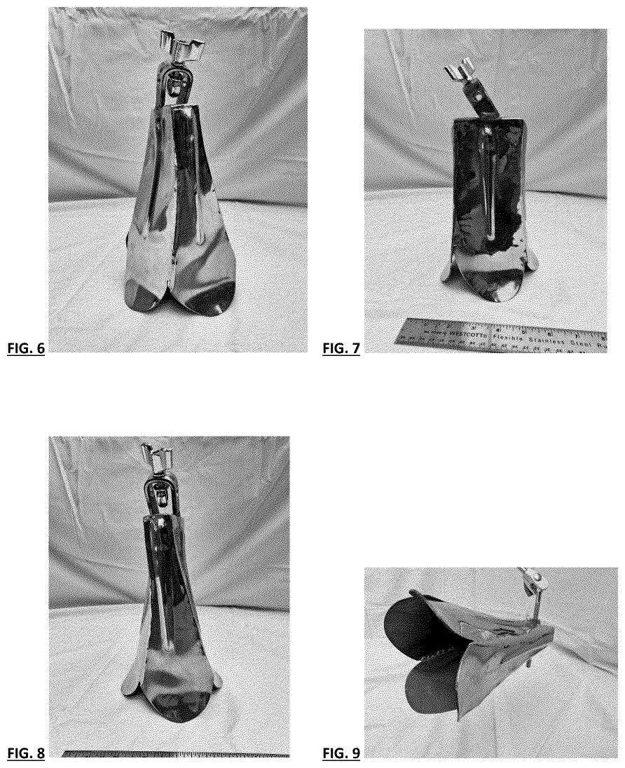

FIG. 6 is a three-quarter upright view photograph of a percussion cowbell showing my new design;

FIG. 7 is a front upright view photograph of a percussion cowbell showing my new design;

FIG. 8 is a front side view photograph of a percussion cowbell showing my new design;

FIG. 9 is a three-quarter side view photograph of a percussion cowbell showing my new design;

1; This claim is for a new construct feature that improves upon the performance of a percussion bell. The new feature of this percussion bell is the inclusion of lips that extend down bast the body of the bell. The inclusion of these lips improves upon the resonance of the bell when struck.
